(19) United States
(12) Patent Application Publication
(10) Pub. No.: US 2026/0291422 A1
(43) Pub. Date: Sep. 24, 2026

(54) SYSTEMS AND METHODS FOR ROTOR FIELD EXCITATION CIRCUIT

(71) Applicant: BorgWarner Inc., Auburn Hills, MI (US)

(72) Inventors: Elanchetchenni ADIAMAN, Sterling Heights, MI (US); Andreas MAYER, Clarkston, MI (US)

(73) Assignee: BorgWarner Inc., Auburn Hills, MI (US)

(21) Appl. No.: 19/088,155

(22) Filed: Mar. 24, 2025

(51) Int. Cl. H02P 25/022; B60L 53/22; H02P 9/30; H02P 27/08

(52) U.S. Cl. CPC H02P 25/022; B60L 53/22; H02P 9/30; H02P 27/08; B60L 2220/14

(57) ABSTRACT

A system includes an excitation circuit for a rotor, the excitation circuit including a full bridge circuit including: a first semiconductor connected to a first voltage node and configured to be connected to a first connection of the rotor; a second semiconductor connected to the first voltage node and configured to be connected to a second connection of the rotor; a third semiconductor configured to be connected to the first connection of the rotor; a fourth semiconductor configured to be connected to the second connection of the rotor; and a disconnect semiconductor connected to a second voltage node, the third semiconductor, and the fourth semiconductor.

### TECHNICAL FIELD

Various embodiments of the present disclosure relate generally to systems and methods for controlling an electrically excited synchronous machine, and, more particularly, to systems and methods for an excitation circuit for a rotor for an electrically excited synchronous machine for an electric vehicle.

### BACKGROUND

Power converters, such as inverters and chargers, are used to drive a motor in an electric vehicle, for example, and are responsible for converting High Voltage Direct Current (HVDC) into Alternating Current (AC) to drive the motor. A switching device for an electrically excited synchronous machine (EESM) may be used as a drive in a hybrid or electric vehicle. The switching device may generate high voltage swings or parasitic currents, which may cause inefficiencies or damage the EESM.

The present disclosure is directed to overcoming one or more of these above-referenced challenges.

### SUMMARY OF THE DISCLOSURE

In some aspects, the techniques described herein relate to a system including an excitation circuit for a rotor, the excitation circuit including a full bridge circuit including: a first semiconductor connected to a first voltage node and configured to be connected to a first connection of the rotor; a second semiconductor connected to the first voltage node and may be configured to be connected to a second connection of the rotor; a third semiconductor may be configured to be connected to the first connection of the rotor; a fourth semiconductor configured to be connected to the second connection of the rotor; and a disconnect semiconductor connected to a second voltage node, the third semiconductor, and the fourth semiconductor.

In some aspects, the techniques described herein relate to a system, wherein: the first semiconductor may include a first diode, the second semiconductor may include a second diode, and the third semiconductor may include a third diode, an anode of the first diode may be connected to the first voltage node and a cathode of the first diode may be configured to be connected to a first connection of the rotor, a cathode of the second diode may be connected to the first voltage node and an anode of the second diode may be configured to be connected to the second connection of the rotor, and an anode of the third diode may be connected to the disconnect semiconductor and a cathode of the third diode may be configured to be connected to the first connection of the rotor.

In some aspects, the techniques described herein relate to a system, wherein the fourth semiconductor may be a transistor.

In some aspects, the techniques described herein relate to a system, wherein the first semiconductor may be a transistor.

In some aspects, the techniques described herein relate to a system, wherein the disconnect semiconductor may be a transistor.

In some aspects, the techniques described herein relate to a system, wherein the disconnect semiconductor may be an insulated gate bipolar transistor (IGBT).

In some aspects, the techniques described herein relate to a system, wherein the first voltage node may be configured to be connected to a positive voltage of a battery, and the second voltage node may be configured to be connected to a negative voltage of the battery.

In some aspects, the techniques described herein relate to a system wherein the first voltage node may be configured to be connected to a negative voltage of a battery, and the second voltage node may be configured to be connected to a positive voltage of the battery.

In some aspects, the techniques described herein relate to a system, wherein the first semiconductor, the fourth semiconductor, and the disconnect semiconductor are configured to pass current during an energizing operation of the rotor.

In some aspects, the techniques described herein relate to a system, wherein the second semiconductor, the third semiconductor, and the disconnect semiconductor are configured to pass current during a de-energizing operation of the rotor.

In some aspects, the techniques described herein relate to a system, wherein the disconnect semiconductor may be configured to be open during a freewheeling operation of the rotor to pass current from the rotor through the fourth semiconductor and the third semiconductor.

In some aspects, the techniques described herein relate to a system, wherein the fourth semiconductor and the disconnect semiconductor are configured to be operable with a single gate driver power supply.

In some aspects, the techniques described herein relate to a system, further including: a battery; a power converter configured to be connected to the battery; and a motor configured to be connected to the power converter, wherein the system may be provided as a vehicle.

In some aspects, the techniques described herein relate to an excitation circuit for a rotor, the excitation circuit including: a first semiconductor connected to a first voltage node and configured to be connected to a first connection of the rotor; a second semiconductor connected to the first voltage node and configured to be connected to a second connection of the rotor; a third semiconductor configured to be connected to the first connection of the rotor; a fourth semiconductor configured to be connected to the second connection of the rotor; and a disconnect semiconductor connected to a second voltage node, the third semiconductor, and the fourth semiconductor.

In some aspects, the techniques described herein relate to an excitation circuit, wherein the fourth semiconductor may be a primary power switch, the disconnect semiconductor may be a secondary power switch, and the first semiconductor may be a tertiary power switch.

In some aspects, the techniques described herein relate to an excitation circuit, wherein the first semiconductor may be an insulated gate bipolar transistor (IGBT).

In some aspects, the techniques described herein relate to an excitation circuit for a rotor, the excitation circuit including: a disconnect semiconductor connected to a full bridge circuit for the rotor and a node configured to be connected to a power source.

In some aspects, the techniques described herein relate to an excitation circuit, wherein the full bridge circuit may be an asymmetric full bridge circuit.

In some aspects, the techniques described herein relate to an excitation circuit, further including: a first sensor to detect a first current at the rotor.

In some aspects, the techniques described herein relate to an excitation circuit, further including: a second sensor to detect a second current at the rotor.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure for a vehicle including a power converter, according to one or more embodiments.

FIG. 2 depicts an exemplary system infrastructure for a power converter and an excitation circuit, according to one or more embodiments.

FIG. 3 depicts an exemplary system infrastructure for a controller, according to one or more embodiments.

FIG. 4 depicts an exemplary excitation circuit, according to one or more embodiments.

FIG. 5 depicts an exemplary excitation circuit for energizing a rotor, according to one or more embodiments.

FIG. 6 depicts an exemplary excitation circuit for de-energizing a rotor, according to one or more embodiments.

FIG. 7 depicts an exemplary excitation circuit for rotor freewheeling, according to one or more embodiments.

FIG. 8 depicts an exemplary three control switch excitation circuit, according to one or more embodiments.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. For example, in the context of the disclosure, switching devices may be described as switches or devices, but may refer to any device for controlling the flow of power in an electrical circuit. For example, switches may be metal-oxide-semiconductor field-effect transistors (MOSFETs), bipolar junction transistors (BJTs), insulated-gate bipolar transistors (IGBTs), or relays, for example, or any combination thereof, but are not limited thereto.

Various embodiments of the present disclosure relate generally to systems and methods for controlling an electrically excited synchronous machine, and, more particularly, to systems and methods for an excitation circuit for a rotor for an electrically excited synchronous machine for an electric vehicle.

Inverters, such as those used to drive a motor in an electric vehicle, for example, are responsible for converting High Voltage Direct Current (HVDC) into Alternating Current (AC) to drive the motor. A three-phase inverter may include a bridge with six power device switches (for example, power transistors such as IGBT or MOSFET) that are controlled by Pulse Width Modulation (PWM) signals generated by a controller. An inverter may include three half-H bridge switches to control the phase voltage, upper and lower gate drivers to control the switches, a PWM controller, and glue logic between the PWM controller and the gate drivers. The PWM controller may generate signals to define the intended states of the system. The gate drivers may send the signals from the PWM controller to the half-H bridge switches. The half-H bridge switches may drive the phase voltage. Six phase (or other phase) inverters, chargers, DC-DC converters, and/or multi-level inverters are not excluded from this concept and will follow similar principles. The present disclosure refers to an inverter as an example embodiment of a power converter. Power converters may include chargers, inverters, or DC-DC converters, for example.

Some solutions use a control method and switching topology for rotor field excitation in electrically excited synchronous machines as drive units in a hybrid or electric vehicle. Some methods may include an asymmetric full bridge circuit with the rotor of the machine connected to a short circuit bridge branch. The bridge switches may be controlled by pulse width modulation corresponding to the desired motor rotational speed and power. The short circuit bridge branch includes a diode in series with a switch in parallel to the rotor. However, the short circuit bridge branch only acts conductively in one direction and is blocked in the opposite direction, maintaining a continuous and unidirectional flow of current through the rotor. The rotor excitation circuit with only the asymmetric full bridge (and without the short circuit branch) may lead to charging and discharging of the parasitic capacitances in the rotor yoke. A displacement current develops through these parasitic capacitances and leads to high frequency electromagnetic compatibility (EMC) interfering currents that can propagate through the rotor shaft and transmission (i.e. bearing currents), as well as propagate through the DC terminals of the power electronics.

One or more embodiments may avoid parasitic capacitances and interfering currents in the rotor shaft and transmission, by balancing the rotor potential and allowing the rotor to freewheel. For example, the above-described short circuit bridge branch may be replaced with a disconnect semiconductor switch connected to a negative connector of the HV battery and one side of a full bridge circuit. The disconnect semiconductor switch may be controlled based on information from sensors positioned to detect currents flowing into and out of the rotor terminals. In some instances, the disconnect semiconductor switch is always on (closed) when the rotor is energized or de-energized. The disconnect semiconductor switch may be opened to allow the rotor to freewheel. De-energizing motors may discharge parasitic capacitances as well as ensure a clean transition to a freewheeling state thereby reducing electromagnetic interference. During freewheeling, the rotor may create a path to control and dissipate interfering currents generated by parasitic capacitances and residual magnetism, thereby preventing damaging voltage spikes. Freewheeling may also reduce the parasitic capacitances.

One or more embodiments may avoid both a short circuit bridge branch parallel to the rotor as well as parasitic capacitances and interfering currents in the rotor shaft and transmission, by using two controlling power switches (e.g., FETs), leading to a reduced circuit complexity and lower cost. For example, a disconnect semiconductor switch, a first control switch, may be connected to a negative connector of the HV battery and one side of a full bridge circuit. A second control switch, a semiconductor switch, may be configured in the full bridge circuit. Both the disconnect semiconductor switch and the second control switch may be configured to be operable with a single (i.e., one and only one) gate driver power supply, thereby providing an added benefit related to component count and cost. This rotor excitation circuit may achieve rotor potential balancing and freewheeling without the need for a dedicated short circuit leg with a diode and switch parallel to a motor load. For example, a secondary switch T2 as the disconnect semiconductor switch may be a switch which is normally ON (closed) and turns OFF (open) with an external gate signal.

One or more embodiments may provide a part reduction benefit on the power switch gate driver circuit, thereby simplifying the circuity design, which may lower production cost and increase efficiency. For example, replacing the above-described short circuit bridge branch with a disconnect semiconductor switch may reduce circuit complexity and lower costs. In such cases, the rotor may be energized by turning on both a primary switch T1 (in a closed position) and a secondary switch T2 (in a closed position). In order to de-energize the rotor, primary switch T1 may be turned off (in an open position) leaving the secondary switch T2 turned on (in a closed position). The secondary switch T2 may be “closed” during normal operations (a rotor energizing state and a rotor de-energizing state) and may be “open” during a rotor freewheeling state. The switching sequence may be controlled based on information from two current sensors monitoring current flowing in and out of the rotor terminals. When parasitic capacitance is depleted to a threshold amount, the primary switch T1 may be turned on (in a closed position) and the secondary switch T2 may be turned off (in an open position) generating a freewheeling state at equal potential by creating a short circuit of the rotor. The switches may be controlled with an external gate signal.

One or more embodiments may provide an added part reduction benefit by controlling a primary switch T1 and a secondary switch T2 with a single, dual channel gate driver. Both power devices T1 and T2 may have a common drain/emitter. Therefore, a single (dual channel) gate driver may be implemented to control the devices, thereby achieving an added part reduction benefit and improving efficiency.

One or more embodiments may improve efficiency by implementing a power switch control configuration with three power switches (T1, T2, and T3). Using three power switches to control the energizing, de-energizing, and freewheeling states of a rotor may improve efficiency by allowing for a unipolar control method to energize and de-energize the rotor. Additional control may only be needed when enabling a rotor short circuit.

One or more embodiments may enhance the functional safety metric of the rotor excitation circuit. For example, the secondary switch T2 may be a FET device. As the secondary switch T2 may normally be turned on (in a closed position), the rotor may automatically be set to de-energize to rotor in cases of failures from the gate or control signals. This safety feature may be employed with two active switches in an asymmetric full bridge stage (e.g., a switch in place of diode D1), which may employ a different control strategy.

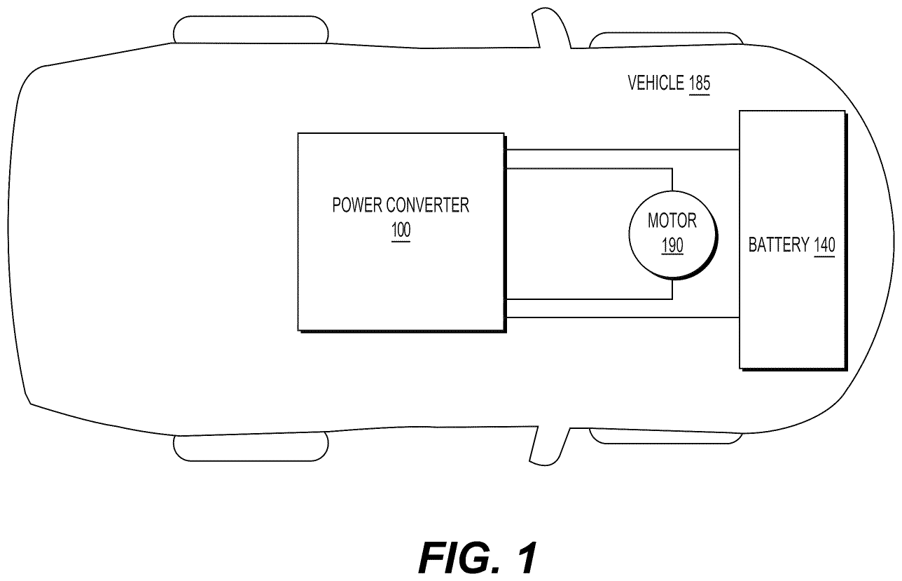

FIG. 1 depicts an exemplary system infrastructure for a vehicle including a power converter, according to one or more embodiments. The power converter 100 may be a combined inverter and converter. Alternatively, the inverter may be an inverter without a converter. In the context of this disclosure, a battery charger, the inverter, the converter, or any combination thereof may be referred to as power converter 100. Electric vehicle 185 may include power converter 100, motor 190, and battery 140. Power converter 100 may include components to receive electrical power from an external source and output electrical power to charge battery 140 of electric vehicle 185. Power converter 100 may convert DC power from battery 140 in electric vehicle 185 to AC power, to drive motor 190 of the electric vehicle 185, for example, but the embodiments are not limited thereto. For example, power converter 100 may include components to receive electrical power from an external source and output electrical power to charge battery 140 without motor 190 connected to power converter 100. Power converter 100 may convert DC power from battery 140 in electric vehicle 185 to AC power, to drive AC components other than motor 190 of the electric vehicle 185. Power converter 100 may be bidirectional, and may convert DC power to AC power, or convert AC power to DC power, such as during regenerative braking, for example. Power converter 100 may be a three-phase inverter, a single-phase inverter, or a multi-phase inverter.

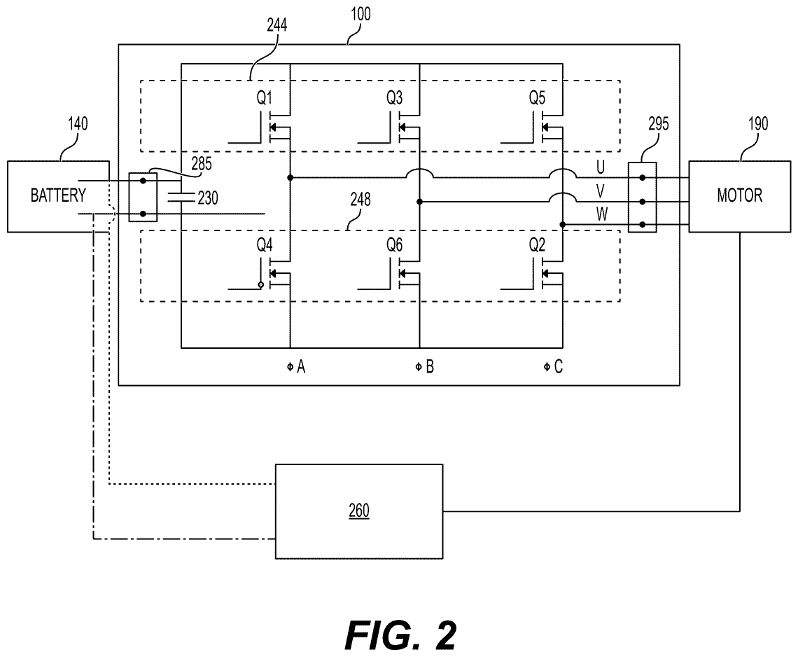

FIG. 2 depicts an exemplary system infrastructure for a power converter and an excitation circuit, according to one or more embodiments. Power converter 100 may be used to convert DC power from a battery 140 in electric vehicle 185 to AC power, to drive motor 190 of electric vehicle 185, for example, but embodiments are not limited thereto. Additionally, power converter 100 may be bidirectional, and used to convert DC power to AC power, or to convert AC power to DC power. Rotor excitation circuit 260 may be used to supply and regulate magnetic field current to rotor windings of motor 190, thereby controlling magnetic flux generation.

Power converter 100 may be connected to battery 140 and motor 190. Power converter 100 may include upper phase switches 244 and lower phase switches 248. A first phase (φA) may include switches Q1 and Q4, a second phase (φB) may include switches Q3 and Q6, and a third phase (φC) may include switches Q5 and Q2. Upper phase switches 244 may include first phase switch Q1, second phase switch Q3, and third phase switch Q5. Lower phase switches 248 may include first phase switch Q4, second phase switch Q6, and third phase switch Q2. Switches Q1-Q6 may be metal-oxide-semiconductor field-effect transistors (MOSFET), for example, but embodiments are not limited thereto.

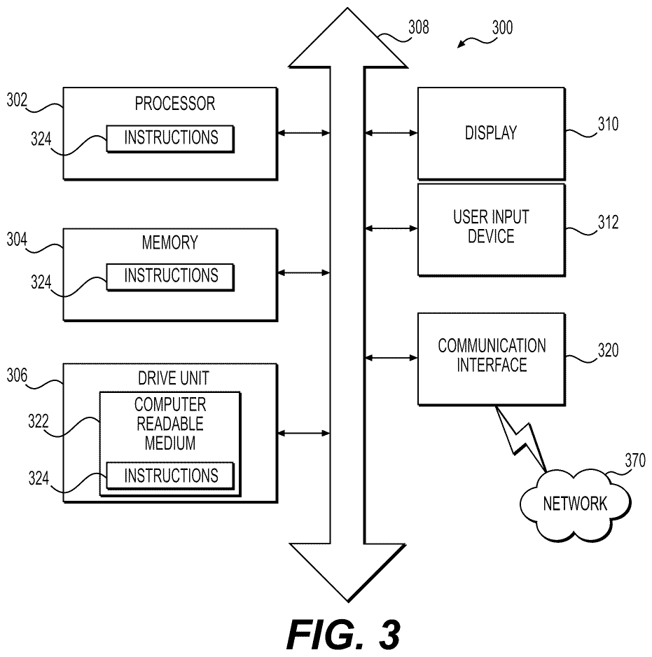

Upper phase switches 244 and lower phase switches 248 may be driven by a pulse width modulated (PWM) signal generated by controller 300 (e.g., see FIG. 3) to convert DC power delivered via the set of input terminals 285 at bulk capacitor 230 to three phase AC power at outputs U, V, and W (correlating with phases A, B, and C, respectively) via the set of output terminals 295 to motor 190. Additionally, although FIG. 2 depicts a three-phase inverter, the disclosure is not limited thereto and may include single phase or multi-phase or multi-level inverters.

Rotor excitation circuit 260 may be connected to battery 140 and motor 190. Rotor excitation circuit 260 may include one or more switching devices, including but not limited to full bridge circuits, asymmetrical full bridge circuits, and other switching circuitry configurations. Rotor excitation circuit 260 may supply current to rotor windings of motor 190 to control a magnetic field in the rotor. Rotor excitation circuit 260 may regulate and control a desired magnetic field strength in the rotor.

FIG. 3 depicts an exemplary system infrastructure for a controller, according to one or more embodiments. Controller 300 may include one or more controllers.

The controller 300 may include a set of instructions that can be executed to cause the controller 300 to perform any one or more of the methods or computer-based functions disclosed herein. The controller 300 may operate as a standalone device or may be connected, e.g., using a network, to other computer systems or peripheral devices.

In a networked deployment, the controller 300 may operate in the capacity of a server or as a client in a server-client user network environment, or as a peer-to-computer system in a peer-to-peer (or distributed) network environment. The controller 300 can also be implemented as or incorporated into various devices, such as a power converter, a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 300 can be implemented using electronic devices that provide voice, video, or data communication. Further, while the controller 300 is illustrated as a single system, the term “system” shall also be taken to include any collection of systems or sub-systems that individually or jointly execute a set, or multiple sets, of instructions to perform one or more computer functions.

As depicted in FIG. 3, the controller 300 may include a processor 302, e.g., a central processing unit (CPU), a graphics processing unit (GPU), or both. The processor 302 may be a component in a variety of systems. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The controller 300 may include a memory 304 that can communicate via a bus 308. The memory 304 may be a main memory, a static memory, or a dynamic memory. The memory 304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 304 includes a cache or random-access memory for the processor 302. In alternative implementations, the memory 304 is separate from the processor 302, such as a cache memory of a processor, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the figures or described herein may be performed by the processor 302 executing the instructions stored in the memory 304. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As depicted, the controller 300 may further include a display 310, such as a liquid crystal display (LCD), an organic light emitting diode (OLED), a flat panel display, a solid-state display, a cathode ray tube (CRT), a projector, a printer or other now known or later developed display device for outputting determined information. The display 310 may act as an interface for the user to see the functioning of the processor 302, or specifically as an interface with the software stored in the memory 304 or in the drive unit 306.

Additionally or alternatively, the controller 300 may include an input device 312 configured to allow a user to interact with any of the components of controller 300. The input device 312 may be a number pad, a keyboard, or a cursor control device, such as a mouse, or a joystick, touch screen display, remote control, or any other device operative to interact with the controller 300.

The controller 300 may also or alternatively include drive unit 306 implemented as a disk or optical drive. The drive unit 306 may include a computer-readable medium 322 in which one or more sets of instructions 324, e.g. software, can be embedded. Further, the instructions 324 may embody one or more of the methods or logic as described herein. The instructions 324 may reside completely or partially within the memory 304 and/or within the processor 302 during execution by the controller 300. The memory 304 and the processor 302 also may include computer-readable media as discussed above.

In some systems, a computer-readable medium 322 includes instructions 324 or receives and executes instructions 324 responsive to a propagated signal so that a device connected to a network 370 can communicate voice, video, audio, images, or any other data over the network 370. Further, the instructions 324 may be transmitted or received over the network 370 via a communication port or interface 320, and/or using a bus 308. The communication port or interface 320 may be a part of the processor 302 or may be a separate component. The communication port or interface 320 may be created in software or may be a physical connection in hardware. The communication port or interface 320 may be configured to connect with a network 370, external media, the display 310, or any other components in controller 300, or combinations thereof. The connection with the network 370 may be a physical connection, such as a wired Ethernet connection or may be established wirelessly as discussed below. Likewise, the additional connections with other components of the controller 300 may be physical connections or may be established wirelessly. The network 370 may alternatively be directly connected to a bus 308.

While the computer-readable medium 322 is depicted to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 322 may be non-transitory and may be tangible.

The computer-readable medium 322 can include a solid-state memory such as a memory card or other package that houses one or more non-volatile read-only memories. The computer-readable medium 322 can be a random-access memory or other volatile re-writable memory. Additionally or alternatively, the computer-readable medium 322 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 300 may be connected to a network 370. The network 370 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including but not limited to TCP/IP based networking protocols. The network 370 may include wide area networks (WAN), such as the Internet, local area networks (LAN), campus area networks, metropolitan area networks, a direct connection such as through a Universal Serial Bus (USB) port, or any other networks that may allow for data communication. The network 370 may be configured to couple one computing device to another computing device to enable communication of data between the devices. The network 370 may generally be enabled to employ any form of machine-readable media for communicating information from one device to another. The network 370 may include communication methods by which information may travel between computing devices. The network 370 may be divided into sub-networks. The sub-networks may allow access to all of the other components connected thereto or the sub-networks may restrict access between the components. The network 370 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component or object distributed processing, and parallel processing. Alternatively, virtual computer system processing can be constructed to implement one or more of the methods or functionalities as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the operations of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

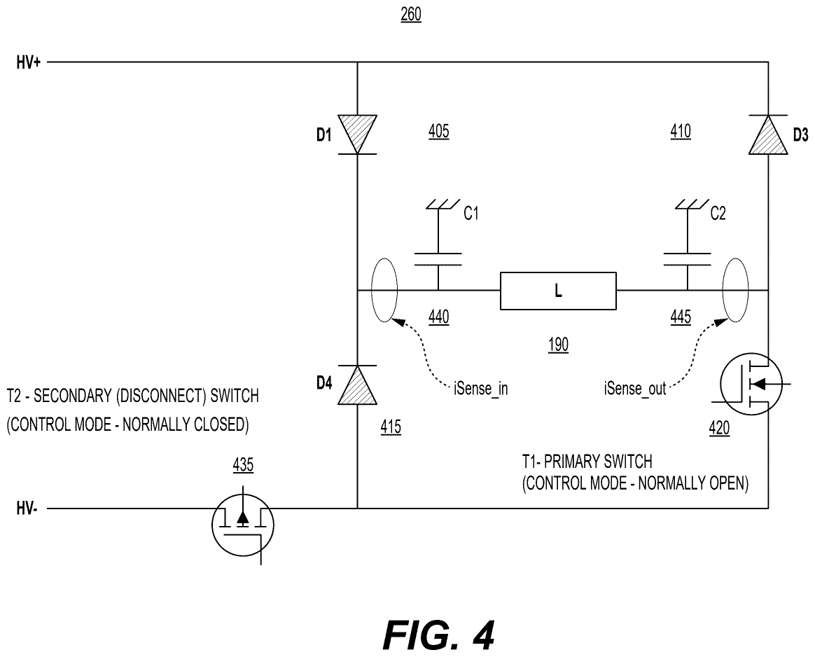

FIG. 4 depicts an exemplary excitation circuit, according to one or more embodiments. Rotor excitation circuit 260 may include a first semiconductor 405, a second semiconductor 410, a third semiconductor 415, a fourth semiconductor 420, a first sensor 440, a second sensor 445, and a disconnect semiconductor 435. First semiconductor 405, second semiconductor 410, third semiconductor 415, and fourth semiconductor 420 may be a full bridge circuit. Rotor excitation circuit 260 may be configured to be connected to battery 140 and motor 190.

First semiconductor 405 may be connected to a first voltage node (e.g., a node configured to be connected to a positive voltage terminal of a power source, e.g., battery 140) and configured to be connected to a first connection of a rotor of motor 190. Second semiconductor 410 may be connected to the first voltage node and configured to be connected to a second connection of the rotor. The third semiconductor 415 may be configured to be connected to the first connection of the rotor. The fourth semiconductor 420 may be configured to be connected to the second connection of the rotor. Fourth semiconductor 420 may be configured as a primary switch (e.g., T1 as described above). Disconnect semiconductor 435 may be configured as a secondary switch (e.g., T2 as described above). Fourth semiconductor 420 and disconnect semiconductor 435 may be configured as power switches.

The disconnect semiconductor 435 may be connected to a second voltage node (e.g., a node configured to be connected to a negative voltage terminal of a power source, e.g., battery 140), the third semiconductor 415, and the fourth semiconductor 420. Disconnect semiconductor 435 may be connected to the full bridge circuit and configured to disconnect the full bridge circuit from the second voltage node. Motor 190 may generate parasitic capacitances C1 and C2 from a field energizing and/or de-energizing operation of rotor excitation circuit 260.

First semiconductor 405 may include a first diode D1. Second semiconductor 410 may include a second diode D3. Third semiconductor 415 may include a third diode D4. Each diode may have an anode and a cathode. For example, an anode of first semiconductor 405 may be connected to the first voltage node, and a cathode of first semiconductor 405 may be configured to be connected to a first connection of the rotor. A cathode of second semiconductor 410 may be connected to the first voltage node, and an anode of second semiconductor 410 may be configured to be connected to the second connection of the rotor. An anode of third semiconductor 415 may be connected to disconnect semiconductor 435, and a cathode of third semiconductor 415 may be configured to be connected to the first connection of the rotor. First semiconductor 405, second semiconductor 410, third semiconductor 415, and fourth semiconductor 420 may comprise a full bridge circuit configuration, an asymmetrical full bridge circuit configuration, or other circuitry configuration. The first voltage node may be configured to be connected to a positive voltage of the battery, and the second voltage node may be configured to be connected to a negative voltage of the battery.

First semiconductor 405 may be a transistor, such as a field effect transistor (FET), a metal oxide semiconductor field effect transistor (MOSFET) transistor, an insulated gate bipolar transistor (IGBT), or other similar transistor. Fourth semiconductor 420 may be a transistor, such as a FET, a MOSFET, an IGBT, or other similar transistor. Disconnect semiconductor 435 may be a transistor, such as a FET, a MOSFET, an IGBT, or other similar transistor. For example, fourth semiconductor 420 may be a primary n-channel field effect transistor (FET). Disconnect semiconductor 435 may be a secondary p-channel FET. In some instances, first semiconductor 405 may be a controlling switching device along with fourth semiconductor 420 and disconnect semiconductor 435.

First sensor 440 may be configured to be connected to the first connection of the rotor of motor 190. Second sensor 445 may be configured to be connected to the second connection of the rotor. First sensor 440 may be connected to a first side of the full bridge circuit. Second sensor 445 may be connected to a second side of the full bridge circuit. First sensor 440 and second sensor 445 may be configured to measure currents into and out of motor 190. First sensor 440 and second sensor 445 may communicate with controller 300.

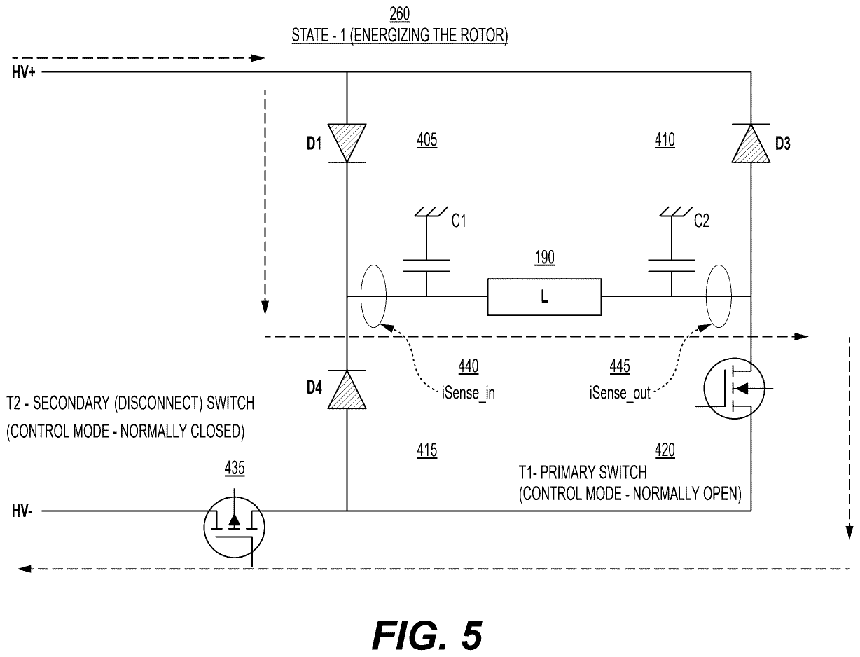

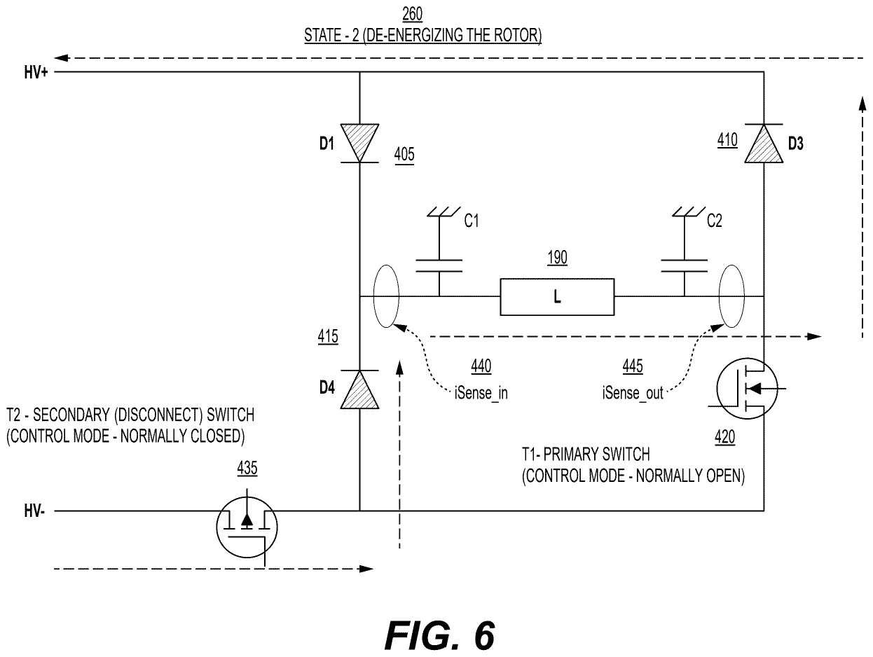

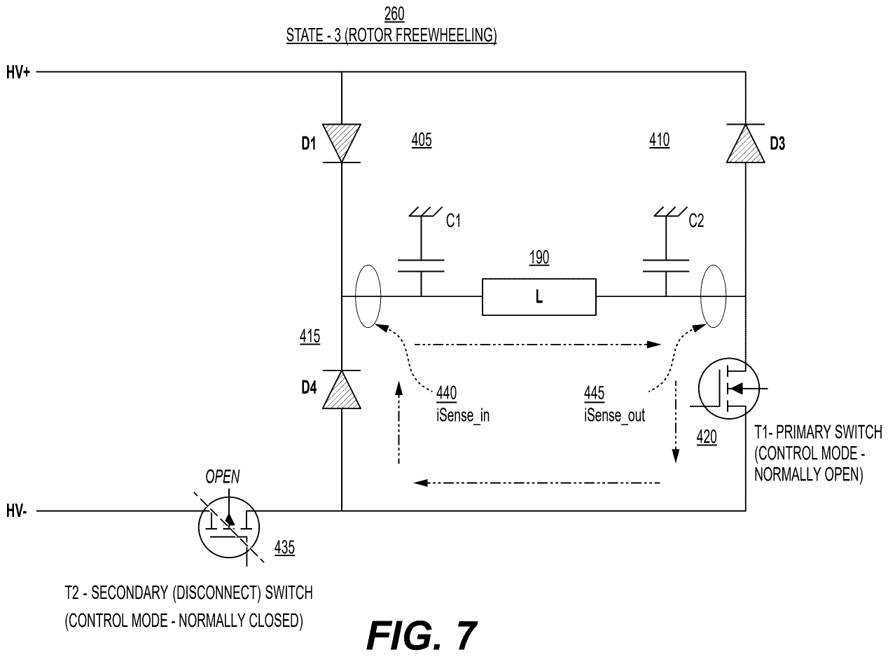

One or more controllers, such as controller 300, may control an operation of one or more of first semiconductor 405, second semiconductor 410, third semiconductor 415, fourth semiconductor 420, or disconnect semiconductor 435. A controller may control an operation of disconnect semiconductor 435, for example, based on information received from first sensor 440 and second sensor 445. For example, based on information received from first sensor 440 and second sensor 445, a controller may determine to energize motor 190 as further discussed in FIG. 5 below, to de-energize motor 190 as further discussed in FIG. 6 below, or to operate motor 190 in a freewheeling state as discussed in FIG. 7 below. The rotor excitation circuit 260 does not require a dedicated short circuit bridge (leg), which requires a diode and additional switch, parallel to motor 190. Fourth semiconductor 420 and disconnect semiconductor 435 may be configured to be operable with a single gate driver power supply. This may simplify the circuitry design, lower cost, and enhance functional safety.

FIG. 5 depicts an exemplary excitation circuit for energizing a rotor, according to one or more embodiments. Rotor excitation circuit 260 may include first semiconductor 405, second semiconductor 410, third semiconductor 415, fourth semiconductor 420, first sensor 440, and second sensor 445 as described in the description of FIG. 4. Rotor excitation circuit 260 may be configured to be connected to motor 190 as described in the description of FIG. 4.

During an energizing operation of the rotor of motor 190, fourth semiconductor 420 may be switched on (in a closed position) and disconnect semiconductor 435 may be switched on (in a closed position). The dotted line illustrates current direction in this circuit configuration. For example, when both fourth semiconductor 420 and disconnect semiconductor 435 are switched on, current may flow (pass) through first semiconductor 405, first sensor 440, motor 190, second sensor 445, fourth semiconductor 420 and disconnect semiconductor 435. In this way, rotor excitation circuit 260 may energize the rotor in motor 190. First sensor 440 and second sensor 445 may monitor the current flowing into and out of the rotor terminals. A controller, such as controller 300, may determine to de-energize the motor, as described in FIG. 6 below, based on information from first sensor 440 and second sensor 445.

FIG. 6 depicts an exemplary excitation circuit for de-energizing a rotor, according to one or more embodiments. Rotor excitation circuit 260 may include first semiconductor 405, second semiconductor 410, third semiconductor 415, fourth semiconductor 420, first sensor 440, and second sensor 445 as described in the description of FIG. 4. Rotor excitation circuit 260 may be configured to be connected to motor 190 as described in the description of FIG. 4.

During a de-energizing operation of the rotor of motor 190, disconnect semiconductor 435 may be turned on (in a closed position) and fourth semiconductor 420 may be turned off (in an open position). The dotted line illustrates current direction in this circuit configuration. For example, when disconnect semiconductor 435 is turned on (in a closed position) and fourth semiconductor 420 is turned off (in an open position), current may flow (pass) through disconnect semiconductor 435, third semiconductor 415, first sensor 440, motor 190, and second semiconductor 410, thereby de-energizing the rotor in motor 190. First sensor 440 and second sensor 445 may monitor the current flowing into and out of rotor terminals. A controller, such as controller 300 may determine to switch motor 190 to a rotor freewheeling state, as described in FIG. 7 below, based on information from first sensor 440 and second sensor 445. For example, information from the two current sensors (e.g., first sensor 440 and second sensor 445) may indicate that parasitic capacitance has been depleted during the de-energizing state and suggest switching to a rotor freewheeling state.

FIG. 7 depicts an exemplary excitation circuit for rotor freewheeling, according to one or more embodiments. Rotor excitation circuit 260 may include first semiconductor 405, second semiconductor 410, third semiconductor 415, fourth semiconductor 420, first sensor 440, and second sensor 445 as described in the description of FIG. 4. Rotor excitation circuit 260 may be configured to be connected to motor 190 as described in the description of FIG. 4.

During a freewheeling operation of the rotor of motor 190, rotor excitation circuit 260 may have disconnect semiconductor 435 turned off (in an open position), and fourth semiconductor 420 may be in an on state (in a closed position). In this circuit configuration, the rotor is short circuited and allows for freewheeling at equal potential. By keeping disconnect semiconductor 435 off and fourth semiconductor 420 on, rotor excitation circuit 260 may keep the rotor in a freewheeling state with the need for pulsing the current. One or more embodiments may avoid parasitic capacitances and interfering currents in the rotor shaft and transmission, by balancing the rotor potential and allowing the rotor to freewheel. For example, the above-described short circuit bridge branch may be replaced with a disconnect semiconductor switch connected to a negative connector of the HV battery and one side of a full bridge circuit. The disconnect semiconductor switch may be controlled based on information from sensors positioned to detect currents flowing into and out of the rotor terminals. In some instances, the disconnect semiconductor switch is always on (closed) when the rotor is energized or de-energized. The disconnect semiconductor switch may be opened to allow the rotor to freewheel. De-energizing motors may discharge parasitic capacitances as well as ensure a clean transition to a freewheeling state thereby reducing electromagnetic interference. During freewheeling, the rotor may create a path to control and dissipate interfering currents generated by parasitic capacitances and residual magnetism, thereby preventing damaging voltage spikes. Freewheeling may also reduce the parasitic capacitances.

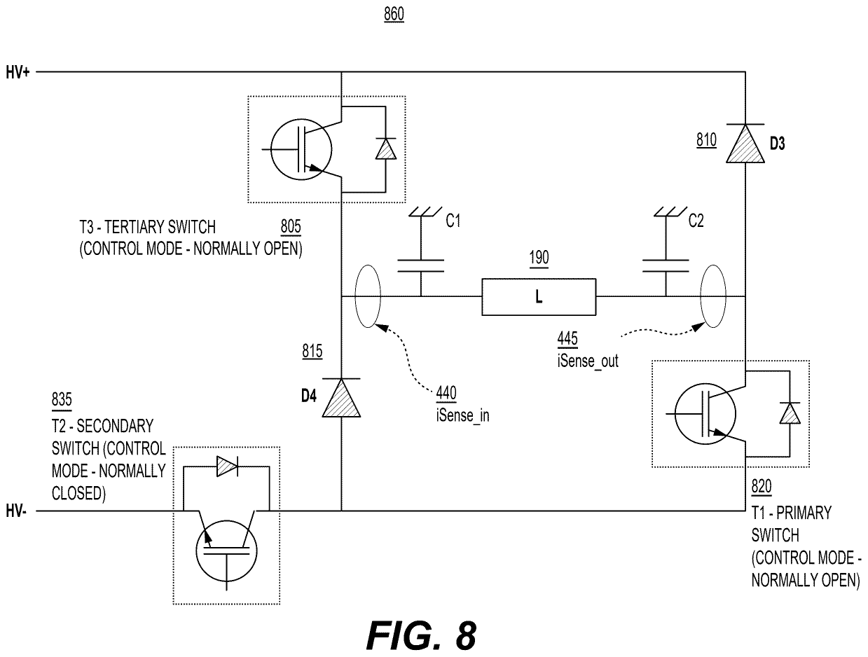

FIG. 8 depicts an exemplary three control switch excitation circuit 860, according to one or more embodiments. Exemplary three control switch excitation circuit 860 may include a primary control switch 820, a secondary control switch 835, a tertiary control switch 805, a first diode 810, a second diode 815, first sensor 440, second sensor 445, and motor 190. First sensor 440, second sensor 445 and motor 190 are described in the description for FIG. 4 above. Tertiary control switch 805, first diode 810, second diode 815, and primary control switch 820 may be a full bridge circuit. Rotor excitation circuit 260 may be configured to be connected to battery 140 and motor 190. Implementing three control switch excitation circuit 860 may improve efficiency by allowing for a unipolar control method to energize and de-energize the rotor. Additional control may only be needed when enabling a rotor short circuit.

Tertiary control switch 805 be connected to the first voltage node (e.g., a node configured to be connected to a positive voltage terminal of a power source, e.g., battery 140) and configured to be connected to a first connection of a rotor of motor 190. First diode 810 may be connected to the first voltage node and configured to be connected to a second connection of the rotor. The second diode 815 may be configured to be connected to the first connection of the rotor. The primary control switch 820 may be configured to be connected to the second connection of the rotor.

Secondary control switch 835 may be connected to the second voltage node (e.g., a node configured to be connected to a negative voltage terminal of a power source, e.g., battery 140), second diode 815, and primary control switch 820. Secondary control switch 835 may be connected to the full bridge circuit and configured to disconnect the full bridge circuit from the second voltage node.

First diode 810 may include an anode and a cathode. First diode 810 may include an anode and a cathode. For example, the cathode of first diode 810 may be connected to the first voltage node, and an anode of first diode 810 may be configured to be connected to the second connection of the rotor. The cathode of second diode 815 may be configured to be connected to the first connection of the rotor, and the anode of second diode 815 may be configured to be connected to secondary control switch 835. Tertiary control switch 805, first diode 810, second diode 815, and primary control switch 820 may comprise a full bridge circuit configuration, an asymmetrical full bridge circuit configuration, or other circuitry configuration. The first voltage node may be configured to be connected to a positive voltage of the battery, and the second voltage node may be configured to be connected to a negative voltage of the battery.

Tertiary control switch 805 may be a transistor, such as a field effect transistor (FET), a metal oxide semiconductor field effect transistor (MOSFET) transistor, an insulated gate bipolar transistor (IGBT), or other similar transistor. Primary control switch 820 may be a transistor, such as a field effect transistor (FET), a metal oxide semiconductor field effect transistor (MOSFET) transistor, an insulated gate bipolar transistor (IGBT), or other similar transistor. Secondary control switch 835 may be a transistor, such as a field effect transistor (FET), a metal oxide semiconductor field effect transistor (MOSFET) transistor, an insulated gate bipolar transistor (IGBT), or other similar transistor.

One or more controllers, such as controller 300, may control an operation of one or more of tertiary control switch 805, primary control switch 820, or secondary control switch 835. A controller may control an operation of secondary control switch 835, for example, based on information received from first sensor 440 and second sensor 445. For example, based on information received from first sensor 440 and second sensor 445, a controller may determine to energize motor 190 as discussed in FIG. 5 above, to de-energize motor 190 as discussed in FIG. 6 above, or to operate motor 190 in a freewheeling state as discussed in FIG. 7 above. The three control switch excitation circuit 860 does not require a dedicated short circuit bridge (leg), which requires a diode and additional switch, parallel to motor 190.

One or more embodiments may avoid parasitic capacitances and interfering currents in the rotor shaft and transmission, by balancing the rotor potential and allowing the rotor to freewheel. For example, the above-described short circuit bridge branch may be replaced with a disconnect semiconductor switch connected to a negative connector of the HV battery and one side of a full bridge circuit. The disconnect semiconductor switch may be controlled based on information from sensors positioned to detect currents flowing into and out of the rotor terminals. In some instances, the disconnect semiconductor switch is always on (closed) when the rotor is energized or de-energized. The disconnect semiconductor switch may be opened to allow the rotor to freewheel. De-energizing motors may discharge parasitic capacitances as well as ensure a clean transition to a freewheeling state thereby reducing electromagnetic interference. During freewheeling, the rotor may create a path to control and dissipate interfering currents generated by parasitic capacitances and residual magnetism, thereby preventing damaging voltage spikes. Freewheeling may also reduce the parasitic capacitances.

One or more embodiments may avoid both a short circuit bridge branch parallel to the rotor as well as parasitic capacitances and interfering currents in the rotor shaft and transmission, by using two controlling switches (e.g., FETs), leading to a reduced circuit complexity and lower cost. For example, a disconnect semiconductor switch, a first control switch, may be connected to a negative connector of the HV battery and one side of a full bridge circuit. A second control switch, a semiconductor switch, may be configured in the full bridge circuit. Both the disconnect semiconductor switch and the second control switch may be configured to be operable with a same gate driver power supply, thereby providing an added benefit related to cost. This rotor excitation circuit may achieve rotor potential balancing and freewheeling without the need for a dedicated short circuit leg with a diode and switch parallel to a motor load.

One or more embodiments may include a simplified circuity design, which may lower production cost and increase efficiency. For example, replacing the above-described short circuit bridge branch with a disconnect semiconductor switch may reduce circuit complexity and lower costs. In such cases, the rotor may be energized by turning on both a primary switch (in a closed position) and a secondary switch (in a closed position). In order to de-energize the rotor, primary switch may be turned off (in an open position) leaving the secondary switch turned on (in a closed position). The switching sequence may be controlled based on information from two current sensors monitoring current flowing in and out of the rotor terminals. When parasitic capacitance is depleted to a threshold amount, the primary switch may be turned on (in a closed position) and the secondary switch may be turned off (in an open position) generating a freewheeling state at equal potential by creating a short circuit of the rotor.

One or more embodiments may enhance the functional safety metric of the rotor excitation circuit. As the secondary switch may normally be turned on (in a closed position), the rotor may automatically be set to de-energize to rotor in cases of failures from the gate or control signals. This safety feature may be employed with two active switches in an asymmetric full bridge stage (e.g., a switch in place of diode D1), which may employ a different control strategy.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system comprising an excitation circuit for a rotor, the excitation circuit including a full bridge circuit including:
a first semiconductor connected to a first voltage node and configured to be connected to a first connection of the rotor;
a second semiconductor connected to the first voltage node and configured to be connected to a second connection of the rotor;
a third semiconductor configured to be connected to the first connection of the rotor;
a fourth semiconductor configured to be connected to the second connection of the rotor; and
a disconnect semiconductor connected to a second voltage node, the third semiconductor, and the fourth semiconductor.

2. The system of claim 1, wherein:
the first semiconductor includes a first diode, the second semiconductor includes a second diode, and the third semiconductor includes a third diode,
an anode of the first diode is connected to the first voltage node and a cathode of the first diode is configured to be connected to a first connection of the rotor,
a cathode of the second diode is connected to the first voltage node and an anode of the second diode is configured to be connected to the second connection of the rotor, and
an anode of the third diode is connected to the disconnect semiconductor and a cathode of the third diode is configured to be connected to the first connection of the rotor.

3. The system of claim 1, wherein the fourth semiconductor is a transistor.

4. The system of claim 3, wherein the first semiconductor is a transistor.

5. The system of claim 1, wherein the disconnect semiconductor is a transistor.

6. The system of claim 1, wherein the disconnect semiconductor is an insulated gate bipolar transistor (IGBT).

7. The system of claim 1, wherein the first voltage node is configured to be connected to a positive voltage of a battery, and the second voltage node is configured to be connected to a negative voltage of the battery.

8. The system of claim 1 wherein the first voltage node is configured to be connected to a negative voltage of a battery, and the second voltage node is configured to be connected to a positive voltage of the battery.

9. The system of claim 1, wherein the first semiconductor, the fourth semiconductor, and the disconnect semiconductor are configured to pass current during an energizing operation of the rotor.

10. The system of claim 1, wherein the second semiconductor, the third semiconductor, and the disconnect semiconductor are configured to pass current during a de-energizing operation of the rotor.

11. The system of claim 1, wherein the disconnect semiconductor is configured to be open during a freewheeling operation of the rotor to pass current from the rotor through the fourth semiconductor and the third semiconductor.

12. The system of claim 1, wherein the fourth semiconductor and the disconnect semiconductor are configured to be operable with a single gate driver power supply.

13. The system of claim 1, further comprising:
a battery;
a power converter configured to be connected to the battery; and
a motor configured to be connected to the power converter,
wherein the system is provided as a vehicle.

14. An excitation circuit for a rotor, the excitation circuit comprising:
a first semiconductor connected to a first voltage node and configured to be connected to a first connection of the rotor;
a second semiconductor connected to the first voltage node and configured to be connected to a second connection of the rotor;
a third semiconductor configured to be connected to the first connection of the rotor;
a fourth semiconductor configured to be connected to the second connection of the rotor; and
a disconnect semiconductor connected to a second voltage node, the third semiconductor, and the fourth semiconductor.

15. The excitation circuit of claim 14, wherein the fourth semiconductor is a primary power switch, the disconnect semiconductor is a secondary power switch, and the first semiconductor is a tertiary power switch.

16. The excitation circuit of claim 14, wherein the first semiconductor is an insulated gate bipolar transistor (IGBT).

17. An excitation circuit for a rotor, the excitation circuit comprising:
a disconnect semiconductor connected to a full bridge circuit for the rotor and a node configured to be connected to a power source.

18. The excitation circuit of claim 17, wherein the full bridge circuit is an asymmetric full bridge circuit.

19. The excitation circuit of claim 17, further comprising:
a first sensor to detect a first current at the rotor.

20. The excitation circuit of claim 19, further comprising:
a second sensor to detect a second current at the rotor.
